(19) United States
(12) Patent Application Publication
(10) Pub. No.: US 2026/0120971 A1
(43) Pub. Date: Apr. 30, 2026

(54) ELECTRIC SWITCH

(71) Applicant: ABB Schweiz AG, Baden (CH)

(72) Inventors: Markus Maki, Seinäjoki (FI); Jarmo Lehtimäki, Vaasa (FI); Kai Uusitalo, Vaasa (FI)

(21) Appl. No.: 19/372,175

(22) Filed: Oct. 28, 2025

(30) Foreign Application Priority Data
Oct. 30, 2024 (EP) 2420985.5

(51) Int. Cl. H01H 9/38; H01H 1/58

(52) U.S. Cl. CPC H01H 9/383; H01H 1/5833

(57) ABSTRACT

An electric switch comprising a frame, a first stationary contact, a roll element configured to rotate relative to the frame, a rotating contact stationarily fixed to the roll element, and an arc shutter system configured to enhance extinguishing of an electric arc between the first stationary contact and the rotating contact during an opening event of the electric switch is described. The arc shutter system comprises a first arc shutter movable relative to the frame between a first position and second position, and a counterpart member configured to cooperate with the first arc shutter in order to enhance extinguishing of the electric arc by squeezing the electric arc between the first arc shutter and the counterpart member.

### CROSS REFERENCE TO RELATED APPLICATIONS

The present application claims priority to European Patent Application No. 24209865.5 filed on Oct. 30, 2024, and titled “ELECTRIC SWITCH”, which is hereby incorporated by reference in its entirety.

### TECHNICAL FIELD

The present disclosure relates to an electric switch.

### BACKGROUND

An electric switch is a device configured to open and close an electric circuit it is connected to. When an electric circuit is opened by an electric switch, an electric arc whose temperature is thousands of degrees may occur in the electric switch. An electric arc includes ionized gas, which contains a large number of free electrons. Such a gas plasma is electrically conductive.

An electric arc delays transfer of an electric switch from a conducting state to a non-conducting state. Further, an electric arc is often harmful for an electric switch and for an electric assembly comprising the electric switch.

It is known in the art to use an arc shutter system to enhance extinguishing of an electric arc during an opening event of an electric switch. Examples of known electric switches provided with arc shutter systems are described in publications EP4376038A1 and EP3985700A1. The arc shutter systems described in said publications are especially efficient in electric switches in which a rotational angle of a rotating contact is relatively large, approximately 90° or larger.

### BRIEF DESCRIPTION

An object of the present disclosure is to provide an electric switch with an arc shutter system capable of efficiently extinguishing an electric arc even when a rotational angle of a rotating contact is relatively small.

The objects of the present disclosure are achieved by the subject-matter of the independent claim. Further exemplary embodiments are evident from the dependent claims and the following description. The embodiments and features, if any, described in this specification that do not fall under the scope of the independent claim are to be interpreted as examples useful for understanding various embodiments of the present disclosure.

The present disclosure provides an arc shutter system which is configured to enhance extinguishing of the electric arc by squeezing the electric arc between a first arc shutter and a counterpart member. The arc shutter system is configured to reduce a cross-sectional area of a route of the electric arc such that the electric arc extinguishes.

An advantage of the electric switch of the present disclosure is that the arc shutter system thereof is capable of efficiently extinguishing an electric arc even when a rotational angle of a rotating contact is relatively small, for example 45°.

An aspect relates to an electric switch comprising a frame, a first stationary contact stationarily fixed to the frame, and configured to be connected to a power supply, a roll element rotatable relative to the frame about a rotation axis between a first position and a second position, a rotating contact stationarily fixed to the roll element, the rotating contact comprising a first contact portion such that in the first position of the roll element the first contact portion is electrically conductively connected to the first stationary contact, and in the second position of the roll element the rotating contact is disconnected from the first stationary contact, and an arc shutter system configured to enhance extinguishing of an electric arc between the first stationary contact and the first contact portion of the rotating contact during an opening event of the electric switch, wherein the arc shutter system comprises a first arc shutter movable relative to the frame between a first arc shutter position and a second arc shutter position, the arc shutter system comprises a counterpart member configured to cooperate with the first arc shutter in order to enhance extinguishing of the electric arc by squeezing the electric arc between the first arc shutter and the counterpart member.

### BRIEF DESCRIPTION OF DRAWINGS

The subject matter of the present disclosure will be explained in more detail in the following text with reference to exemplary embodiments which are illustrated in the attached drawings.

FIGS. 1 to 3 show a switch assembly comprising an electric switch according to an embodiment of the present disclosure.

FIG. 4 shows a portion of the switch assembly shown in FIG. 3 according to an embodiment of the present disclosure.

FIG. 5 is a side view of the portion of the switch assembly shown in FIG. 4 according to an embodiment of the present disclosure.

FIG. 6 shows a side view of a mechanism of an electric switch according to another embodiment of the present disclosure.

FIG. 7 shows a side view of a mechanism of an electric switch according to yet another embodiment of the present disclosure.

FIGS. 8 and 9 show side views of a mechanism of an electric switch according to yet another embodiment of the present disclosure.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

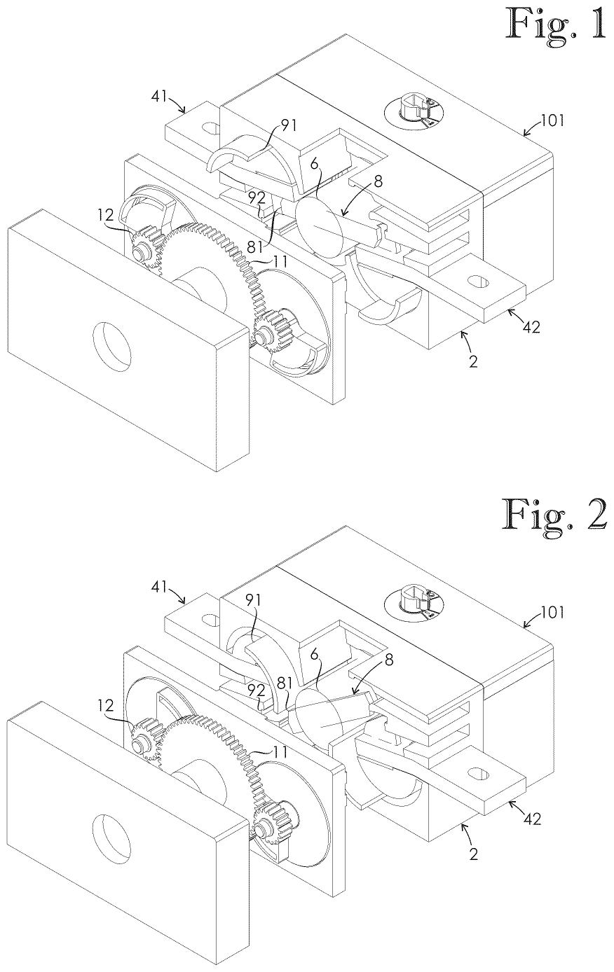

FIG. 1 shows a switch assembly comprising an electric switch according to an embodiment of the present disclosure, and a control module 101 configured to control the electric switch. In FIG. 1, the switch assembly is partly disassembled in order to show an internal structure of the switch assembly.

The electric switch shown in FIG. 1 comprises a frame 2, a first stationary contact 41, a second stationary contact 42, a roll element 6, a rotating contact 8, an arc shutter system and a transmission mechanism.

The first stationary contact 41 is stationarily fixed to the frame 2 and is configured to be connected to a power supply. The second stationary contact 42 is stationarily fixed to the frame 2 and is configured to be connected to a load. The roll element 6 is configured to rotate relative to the frame 2 around a rotation axis between a first position and second position.

A rotational angle of the roll element 6 between the first position and the second position is 45°. In an alternative embodiment, a rotational angle of the roll element around the rotation axis is limited to an angle less than or equal to 70°. In another alternative embodiment, a rotational angle of the roll element around the rotation axis is limited to an angle less than or equal to 120°.

The rotating contact 8 is stationarily fixed to the roll element 6, and comprises a first contact portion 81. In FIG. 1, the roll element 6 is in the first position thereof, in which the first contact portion 81 is electrically conductively connected to the first stationary contact 41. The first position of the roll element 6 provides an on-position or connected position of the electric switch in which the rotating contact 8 electrically conductively connects the first stationary contact 41 and the second stationary contact 42.

The first stationary contact 41 and the first contact portion 81 of the rotating contact 8 are configured to cooperate as knife contacts or blade contacts. This means that in the first position of the roll element 6, an electric current is configured to flow between the first stationary contact 41 and the first contact portion 81 generally in a direction parallel to the rotation axis.

The arc shutter system is configured to enhance extinguishing of an electric arc between the first stationary contact 41 and the first contact portion 81 of the rotating contact 8 during an opening event of the electric switch. The opening event is an event in which the electric switch transfers from the on-position to an off-position or disconnected position.

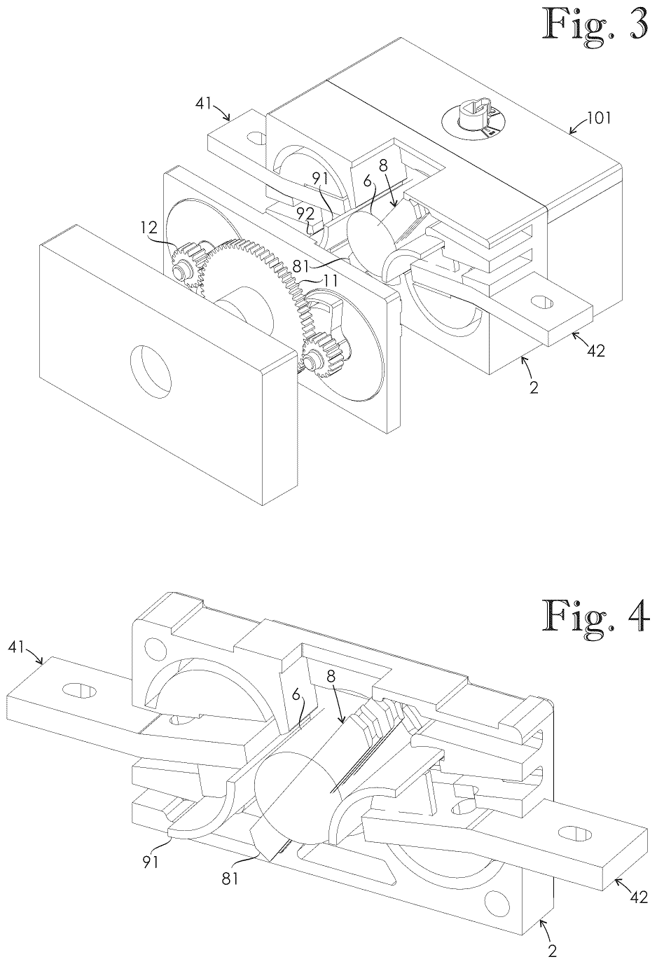

In FIG. 2, the electric switch is in an intermediate position between the on-position and the off-position. In FIG. 3, the electric switch is in the off-position.

The arc shutter system comprises a first arc shutter 91 and a counterpart member 92. The counterpart member 92 is configured to cooperate with the first arc shutter 91 in order to enhance extinguishing of the electric arc by squeezing the electric arc between the first arc shutter 91 and the counterpart member 92.

The first arc shutter 91 is movable relative to the frame 2 between a first position and second position. The counterpart member 92 is stationary relative to the frame 2. The first arc shutter 91 and the counterpart member 92 are made of electrically insulating materials.

In the first position of the first arc shutter 91 shown in FIG. 1, the arc shutter system enables an electrically conducting contact between the first stationary contact 41 and the first contact portion 81 of the rotating contact 8. In the second position of the first arc shutter 91 shown in FIG. 3, the first arc shutter 91 blocks a route on which the electric arc would be located if it was not for the first arc shutter 91. In the second position of the first arc shutter 91, the first arc shutter 91 is located on a rotating contact path through which the rotating contact 8 moves during rotation between the first position and the second position of the roll element 6.

The transmission mechanism is configured to transfer power from the roll element 6 to the first arc shutter 91 such that rotation of the roll element 6 moves the first arc shutter 91 relative to the frame 2. In the first position of the roll element 6, the first arc shutter 91 is in the first position of the first arc shutter 91. In the second position of the roll element 6, the first arc shutter 91 is in the second position of the first arc shutter 91.

In an alternative embodiment, the transmission mechanism is configured to transfer power to the arc shutter system from another component of the electric switch configured to move during the opening event.

In FIG. 2, the first arc shutter 91 is in an intermediate position between the first position and the second position thereof. In FIG. 3, the first arc shutter 91 is in the second position thereof.

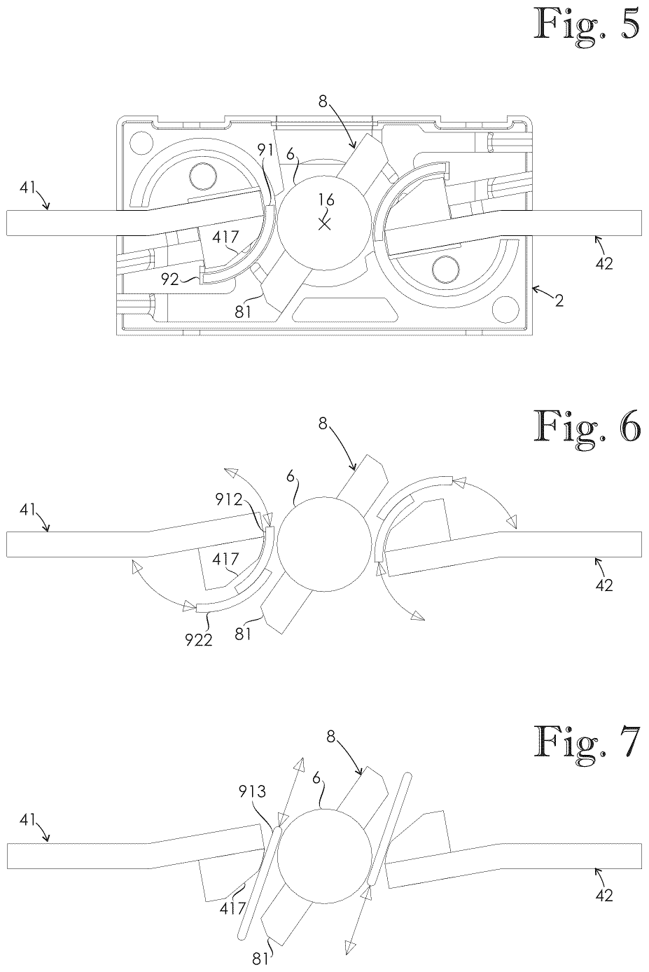

FIG. 4 shows a portion of the switch assembly shown in FIG. 3. FIG. 5 is a side view of the portion of the switch assembly shown in FIG. 4. In FIGS. 4 and 5, the electric switch is in the off-position.

The first arc shutter 91 is rotatable relative to the frame 2 around a shutter axis between the first position and second position. The shutter axis is parallel with the rotation axis 16. The shutter axis is spaced apart from the rotation axis 16 such that in a longitudinal direction perpendicular to the rotation axis 16, an arc section 417 of the first stationary contact 41 is located between the rotation axis 16 and the shutter axis. The arc section 417 is a section of the first stationary contact 41 on which an end of the electric arc is located during the opening event. In FIG. 5, the longitudinal direction is the horizontal direction.

The first arc shutter 91 has a curved form. The first arc shutter 91 has an inner shutter surface and an outer shutter surface each of which has a shape of a segment of a cylindrical surface of a circular right cylinder. Centre line of the circular right cylinders coincide with the shutter axis.

A lateral dimension of the first arc shutter 91 is greater than a lateral dimension of the first contact portion 81 and greater than a lateral dimension of the arc section 417 of the first stationary contact 41. In an embodiment, a lateral dimension of the first arc shutter is at least one centimeter greater than a lateral dimension of the first contact portion and at least one centimeter greater than a lateral dimension of the arc section of the first stationary contact. The lateral dimensions are parallel to the rotation axis.

As best seen in FIG. 5, at the final stage of the movement of the first arc shutter 91 from the first position to the second position, the first arc shutter 91 moves towards the counterpart member 92. The counterpart member 92 has a recess configured to receive a leading edge of the first arc shutter 91.

In the second position of the first arc shutter 91, there is a small gap between the first arc shutter 91 and the counterpart member 92. In an embodiment, in the second position of the first arc shutter, a distance between the first arc shutter and the counterpart member is less than or equal to 1.5 mm. In another embodiment, in the second position of the first arc shutter, a distance between the first arc shutter and the counterpart member is less than or equal to 1.0 mm.

In general, the smaller the gap between the first arc shutter and the counterpart member, the better. In some embodiments, a small gap between the first arc shutter and the counterpart member is allowed in order to take into account manufacturing tolerances in the electric switch, for example in the transmission mechanism.

In an alternative embodiment, in the second position of the first arc shutter, the first arc shutter is in contact with the counterpart member such that a route of the electric arc is closed. In said alternative embodiment, a contact surface of the first arc shutter and/or a contact surface of the counterpart member is made of elastic material, wherein said contact surfaces are surfaces that are configured to be in contact with each other in the second position of the first arc shutter. Due to the elastic material of the at least one contact surface, there is no gap between the first arc shutter and the counterpart member in the second position of the first arc shutter even if one or both of the contact surfaces wear or erode.

In a further alternative embodiment, in the second position of the first arc shutter, the first arc shutter is in contact with the counterpart member and the transmission mechanism is provided with a spring system allowing to compensate for any manufacturing tolerances in the electric switch such that the contact with the first arc shutter and the counterpart member does not jam the transmission mechanism.

FIGS. 1 to 3 show that the transmission mechanism comprises a first cogwheel 11 stationarily connected relative to the roll element 6, and a second cogwheel 12 stationarily connected relative to the first arc shutter 91. The first cogwheel 11 has more cogs than the second cogwheel 12. Due to the gear ratio of the transmission mechanism, a rotational angle between the first position and second position of the first arc shutter 91 is greater than a rotational angle between the first position and second position of the roll element 6.

In an embodiment, a transmission ratio of the transmission mechanism is such that a rotational angle between the first position and second position of the first arc shutter is greater than or equal to 300% of a rotational angle between the first position and second position of the roll element.

FIG. 6 shows a side view of a mechanism of an electric switch according to another embodiment of the present disclosure. Except for the arc shutter system and the transmission mechanism, the electric switch of FIG. 6 is identical with the electric switch shown in FIGS. 1 to 5.

In the embodiment shown in FIG. 6, the arc shutter system comprises a first arc shutter 912 and a counterpart member 922. The first arc shutter 912 is movable relative to the frame between a first position and second position. The counterpart member 922 is movable relative to the frame between a first position and second position.

The first arc shutter 912 is rotatable relative to the frame around a shutter axis between the first position and second position. The shutter axis is parallel with the rotation axis of the roll element 6. The shutter axis is spaced apart from the rotation axis such that in a longitudinal direction perpendicular to the rotation axis, the arc section 417 of the first stationary contact 41 is located between the rotation axis and the shutter axis.

The counterpart member 922 is rotatable relative to the frame around a counterpart member axis between the first position and second position. The counterpart member axis coincides with the shutter axis.

The first arc shutter 912 has a curved form. The first arc shutter 912 has an inner shutter surface and an outer shutter surface each of which has a shape of a segment of a cylindrical surface of a circular right cylinder. Centre lines of the circular right cylinders coincide with the shutter axis.

The counterpart member 922 has a curved form. The counterpart member 922 has an inner counterpart surface and an outer counterpart surface each of which has a shape of a segment of a cylindrical surface of a circular right cylinder. Centre lines of the circular right cylinders coincide with the shutter axis. A radius of the inner counterpart surface of the counterpart member 922 is greater than a radius of the outer shutter surface of the first arc shutter 912.

FIG. 6 shows the arc shutter system in the off-position of the electric switch in which the first arc shutter 912 and the counterpart member 922 overlap.

FIG. 7 shows a side view of a mechanism of an electric switch according to yet another embodiment of the present disclosure. Except for the arc shutter system and the transmission mechanism, the electric switch of FIG. 7 is identical with the electric switch shown in FIGS. 1 to 5.

In the embodiment shown in FIG. 7, the arc shutter system comprises a first arc shutter 913 and a counterpart member (not shown). The first arc shutter 913 is movable relative to the frame between a first position and second position. The counterpart member is stationary relative to the frame.

The first arc shutter 913 is configured to move rectilinearly between the first position and second position. The first arc shutter 913 has a form of a planar quadrilateral.

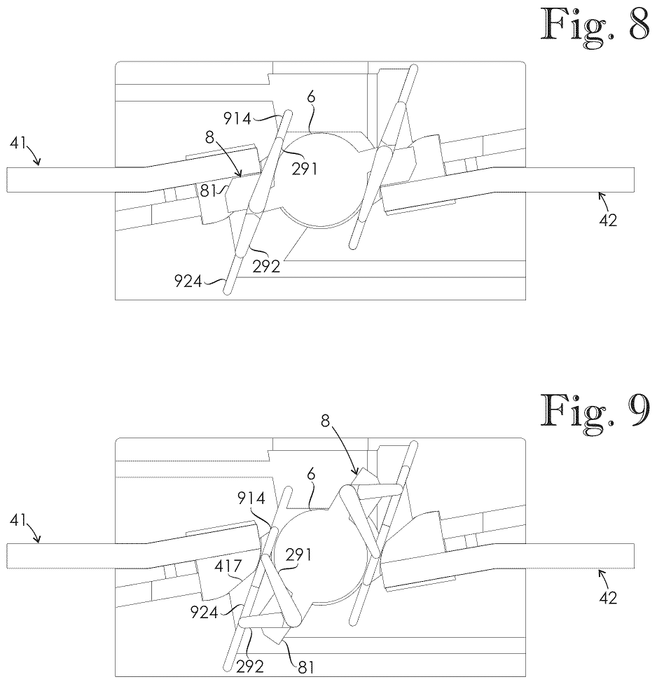

FIG. 8 shows a side view of a mechanism of an electric switch according to yet another embodiment of the present disclosure. Except for the arc shutter system and the transmission mechanism, the electric switch of FIG. 8 is identical with the electric switch shown in FIGS. 1 to 5.

In the embodiment shown in FIG. 8, the arc shutter system comprises a first arc shutter 914 and a counterpart member 924. The first arc shutter 914 is movable relative to the frame between a first position and second position. The counterpart member 924 is movable relative to the frame between a first position and second position.

The first arc shutter 914 is configured to move rectilinearly between the first position and second position. The first arc shutter 914 has a form of a planar quadrilateral.

The counterpart member 924 is configured to move rectilinearly between the first position and second position. The counterpart member 924 has a form of a planar quadrilateral.

FIG. 8 shows the arc shutter system in the on-position of the electric switch in which the first arc shutter 914 and the counterpart member 924 are spaced apart. FIG. 8 also shows a first transmission lever 291 configured to move the first arc shutter 914, and a second transmission lever 292 configured to move the counterpart member 924. In FIG. 8, the first transmission lever 291 partly obscures the first arc shutter 914, and the second transmission lever 292 partly obscures the counterpart member 924.

FIG. 9 shows the arc shutter system of FIG. 8 in the off-position of the electric switch in which the first arc shutter 914 is in contact with the counterpart member 924 such that a route of the electric arc is closed. In FIG. 9, the first arc shutter 914 can be seen better than in FIG. 8 since the first transmission lever 291 obscures the first arc shutter 914 less than in FIG. 8.

In an embodiment not shown in the Figures, the first arc shutter is rotatable relative to the frame around a shutter axis between the first position and second position such that the shutter axis coincides with the rotation axis of the roll element, wherein the first arc shutter is fixed to the roll element. In said embodiment, the first arc shutter is configured to rotate eccentrically such that at the final stage of the movement of the first arc shutter from the first position to the second position, the first arc shutter moves towards the counterpart member thereby enhancing the squeezing effect of the arc shutter system.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An electric switch comprising:
a frame;
a first stationary contact stationarily fixed to the frame, and configured to be connected to a power supply;
a roll element rotatable relative to the frame about a rotation axis between a first position and a second position;
a rotating contact stationarily fixed to the roll element, the rotating contact comprising a first contact portion such that in the first position of the roll element the first contact portion is electrically conductively connected to the first stationary contact, and in the second position of the roll element the rotating contact is disconnected from the first stationary contact; and
an arc shutter system configured to enhance extinguishing of an electric arc between the first stationary contact and the first contact portion of the rotating contact during an opening event of the electric switch, wherein:
the arc shutter system comprises a first arc shutter movable relative to the frame between a first arc shutter position and a second arc shutter position,
the arc shutter system comprises a counterpart member configured to cooperate with the first arc shutter in order to enhance extinguishing of the electric arc by squeezing the electric arc between the first arc shutter and the counterpart member.

2. The electric switch as claimed in claim 1, wherein at a final stage of a movement of the first arc shutter from the first position to the second position, the first arc shutter moves towards the counterpart member.

3. The electric switch as claimed in claim 1, wherein, in the second position of the first arc shutter, a distance between the first arc shutter and the counterpart member is less than or equal to 1.5 mm.

4. The electric switch as claimed in claim 1, wherein, in the second position of the first arc shutter, the first arc shutter is in contact with the counterpart member such that a route of the electric arc is closed.

5. The electric switch as claimed in claim 4, wherein:
a contact surface of the first arc shutter and/or a contact surface of the counterpart member is made of elastic material,
the contact surfaces are surfaces that are configured to be in contact with each other in the second position of the first arc shutter.

6. The electric switch as claimed in claim 1, wherein the first arc shutter is rotatable relative to the frame around a shutter axis between the first arc shutter position and second arc shutter position.

7. The electric switch as claimed in claim 6, wherein:
the shutter axis is spaced apart from the rotation axis such that in a longitudinal direction perpendicular to the rotation axis, an arc section of the first stationary contact is located between the rotation axis and the shutter axis, and
the arc section is a section of the first stationary contact on which an end of the electric arc is located during the opening event.

8. The electric switch as claimed in claim 6, wherein a rotational angle between the first arc shutter position and second arc shutter position is greater than a rotational angle between the first position and second position of the roll element.

9. The electric switch as claimed in claim 1, wherein the electric switch comprises a transmission mechanism configured to transfer power to the arc shutter system from a component of the electric switch configured to move during the opening event.

10. The electric switch as claimed in claim 9, wherein the transmission mechanism is configured to transfer power from the roll element to the first arc shutter such that rotation of the roll element moves the first arc shutter relative to the frame.

11. The electric switch as claimed in claim 10, wherein the transmission mechanism comprises a first cogwheel stationarily connected relative to the roll element, and a second cogwheel stationarily connected relative to the first arc shutter.

12. The electric switch as claimed in claim 1, wherein:
a lateral dimension of the first arc shutter is greater than a lateral dimension of the first contact portion and greater than a lateral dimension of an arc section of the first stationary contact,
the arc section is a section of the first stationary contact on which an end of the electric arc is located during the opening event, and
the lateral dimensions are parallel to the rotation axis.

13. The electric switch as claimed in claim 1, wherein the first stationary contact and the first contact portion of the rotating contact are configured to cooperate as knife contacts.

14. The electric switch as claimed in claim 1, wherein a rotational angle of the roll element about the rotation axis is limited to an angle less than or equal to 120°.

15. The electric switch as claimed in claim 2, wherein in the second position of the first arc shutter, a distance between the first arc shutter and the counterpart member is less than or equal to 1.5 mm.

16. The electric switch as claimed in claim 2, wherein in the second position of the first arc shutter, the first arc shutter is in contact with the counterpart member such that a route of the electric arc is closed.

17. The electric switch as claimed in claim 16, wherein:
a contact surface of the first arc shutter and/or a contact surface of the counterpart member is made of elastic material, and
said contact surfaces are surfaces that are configured to be in contact with each other in the second position of the first arc shutter.

18. The electric switch as claimed in claim 2, wherein the first arc shutter is rotatable relative to the frame around a shutter axis between the first arc shutter position and second arc shutter position.

19. The electric switch as claimed in claim 18, wherein:
the shutter axis is spaced apart from the rotation axis such that in a longitudinal direction perpendicular to the rotation axis, an arc section of the first stationary contact is located between the rotation axis and the shutter axis, and
the arc section is a section of the first stationary contact on which an end of the electric arc is located during the opening event.

20. The electric switch as claimed in claim 18, wherein a rotational angle between the first arc shutter position and second arc shutter position is greater than a rotational angle between the first position and second position of the roll element.
